(19) United States
(12) Patent Application Publication
(10) Pub. No.: US 2016/0107773 A1
(43) Pub. Date: Apr. 21, 2016

(54) METHOD OF PRODUCTION OF A FOOD PRODUCT PACKAGED IN TUBES

(71) Applicant: Sergey Vyacheslavovich ARZAMASTSEV, St. Petersburg (RU)

(72) Inventor: Sergey Vyacheslavovich ARZAMASTSEV, St. Petersburg (RU)

(21) Appl. No.: 14/514,810

(22) Filed: Oct. 15, 2014

(51) Int. Cl. B65B 5/08; A23L 1/325; A23L 1/31; A21D 13/00; A23C 19/09

(52) U.S. Cl. CPC B65B 5/08; A21D 13/0067; A23C 19/0908; A23L 1/3106; A23L 1/3255; A23V 2002/00

(57) ABSTRACT

The invention refers to the nutrition industry. A tube is used for packing, storing, transportation and sale of a food product. A method of production of the food product packaged in tubes is disclosed, the tube being injected by bread, with that the tuba is either single-chambered or consists of two and more chambers. The method is characterized by the fact that bread is used in the form of paste or small fragments. The bread is crushed to formation of a paste-like condition, proportion per 100 g of the product is 50-90 g of bread, 10-50 g of the processed or other cheese. Alternatively, the proportion per 100 g of the product is 50-90 g of bread, 10-50 g of meat, fish or other type of paste. Additionally the tube is filled in, depending on recipe, with ketchup, mayonnaise, mustard.

This invention claims priority to Russian application No. RU2014125936 filed on Jun. 26, 2014.

The invention refers to the nutrition industry. A tube is used for packing, storing, transportation and sale of a food product.

The nutrition of participants involved in the ground model experiment imitating flight to Mars is known (Patent of the Russian Federation No. 2426456, A23L1/48, priority date Aug. 31, 2010).

This process provides for 3 stages. The 1^{st} stage from the 1^{st} to the 250^{th} day, imitating flight to Mars, includes 5-course meal by semi-finished products of ready-made meals with the energy value of a breakfast 19-21%, a dinner of 29-31%, a supper of 29-31% and two intermediate food intakes with the energy value of each 9-11% of the daily energy content of the day food products. The 2^{nd} stage from the 251^{st} to the 280^{th} day, imitating flight in an orbit of Mars and landing to its surface, is represented by two types of meals, one of which is provided for a group imitating landing and work on the surface of Mars, and includes 4-course meals with the energy value of a breakfast of 19-21%, the 2nd breakfast of 14-16%, a dinner of 34-36% and a supper of 29-31% of the daily energy content of the day food products. With that for this group the tinned, ready-made cold, first dishes reconstituted by hot water and hot drinks are used. The 3^{rd} stage from the 281st to the 520th day, imitating flight to Earth, provides 4-course meal in the form of ready-made meals of sublimation dehydration with the energy value of a breakfast of 24-26%, a dinner of 34-36%, a supper of 24-26% and intermediate food intakes of 14-16% of the daily energy content of the day food products. The 2^{nd} stage provides the meal similar to those at the 3^{rd} stage for the remaining people, imitating flight in the orbit of Mars.

The invention is intended to create the feeding method of the long-term autonomy, with the food ration of the set energy value that preserves the biological full-value and microbiological safety throughout the whole term of experiment in the absence of possibility to replenish the food stock, taking into account various stages of activity during the flight to Mars, with the use of the serially manufactured food products of the mass consumption.

The analog has a restriction on possibility of its use on earth.

There are two offered sets imitating food for astronauts, known: Kosmosnek and Kosmofood 2.0. (see the web-site http://space-food.ru/#products)

They differ in structure. So, the set Kosmosnek consists of juice in a tube, separate bread, black or white (at option) and tea or coffee (at option) (see bigbuzzy.ru/catalog/x-line)

Food imitation for astronauts is unacceptable for the mass-market and is rather a curiosity.

The method of production of the food products packaged in tubes is well-known (see the web-site http://www.obobrali.ru/2012/04/eda-v-tyubikah-dlya-sovetskih-kosmonavtov/). However, even though this method can serve as the closest analog of the declared offer, it is also unique, intended for astronauts. The product in a tube does not contain bread, tubes are one-chambered, “discharge” one type of food, are semi-finished. The best way it is possible to use is to make a sandwich.

The main feature of the proposed solution unlike to analogs is that the products in this situation are not auxiliary, nor intermediate, but used directly for meal. The product in tubes serves as a main course, and salt, spices, seasonings may be contained both as in the product, as in additional chambers of the tube.

The offered product is final that can be used for meal directly, without additional ingredients, as, for example, usual sandwich, hot dog or a wrap sandwich.

The offered product is a novel in the fast food. It is very convenient, you can take it along anywhere, it doesn't take a lot of space, doesn't leave crumbs, it's not necessary to wash hands after it; you don't require a plate and tableware. You can give it to children to school, take it along for work, on a journey, for a trip, in a car. You can eat it at any time in any place, without being afraid to get dirty.

Technical result of the proposed solution is readiness of the food product for use directly as 100% ready-made product.

There is offered the method of production of the food product packaged in tubes, which is characterized as being injected by bread, therewith the tube is a single-chambered or consisting of two and more chambers.

The method of production of the food product is characterized by the use of bread in the form of paste or small fragments.

The method of production of the food product is featured by bread, which is crushed to formation of a paste-like condition, in proportion 50-90 g of bread, 10-50 g of the processed or other cheese, per 100 g of the product.

The method of production of the food product is featured by bread, which is crushed to formation of a paste-like condition, in proportion 50-90 g of bread, 10-50 g of meat, fish or another type of spread per 100 g of the product.

The method of production of the food product is featured by bread, which is crushed to formation of a paste-like condition, in proportion 50-90 g of bread, 5-25 g of meat, fish or another type of spread, 5-25 g of the processed cheese per 100 g of the product.

The method of production of the food product is characterized by additional filling, if necessary, depending on receipt, with 0-20 g of ketchup, 0-20 g of mayonnaise, 0-20 g of mustard, therewith obtaining proportion per 100 g of the product.

In different recipes different types of bread or bakery products are used: white bread, roll, black bread, buckwheat bread, unleavened, crackers, etc. The bread is grinded through a meat grinder or crushed in another way before becoming like a paste or in small fragments (crumbs). Implementing the proposed solution the Russian proverb comes to a mind. “Bread is a head of everything”.

Convenience of a tube is that it is tolerant to turnover; the consumer is protected from spots on clothes, furniture and various surfaces. The tube will not break up when falls; it allows the consumer easy dosing a product without the supplementary tools. The tube reliably protects a product against environmental influence, it is hermetically closed right after use, and the product will not spoil for a long time.

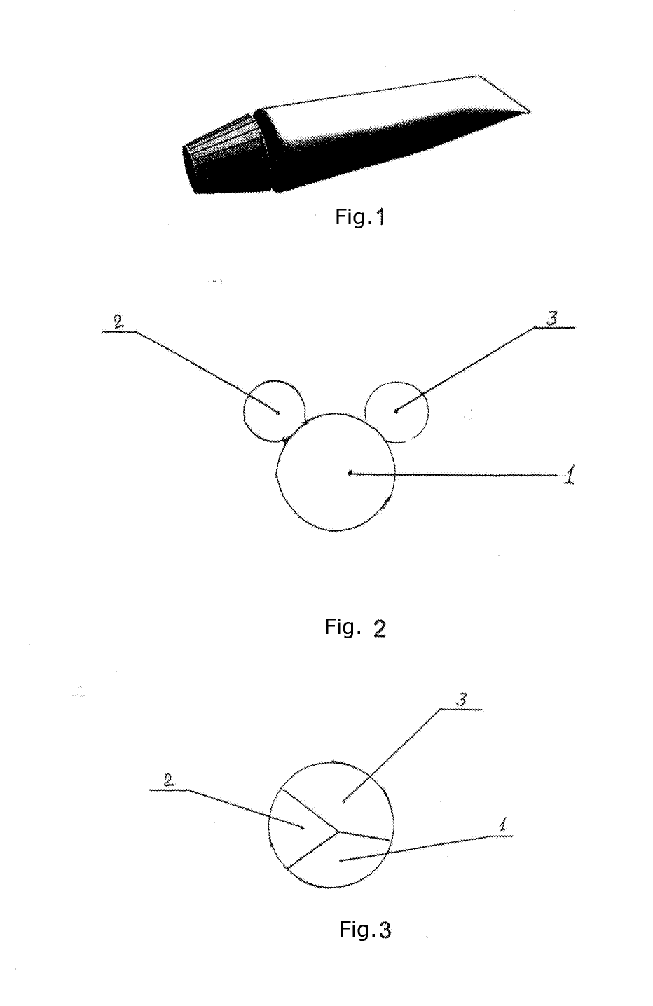

At the drawings you can see the tube (FIG. 1), it is usually a package of cylindrical form with a cap. The tube can be one-, two- or multi-chambered. FIG. 2 shows the tube (end view) with three chambers 1,2,3, with a flat bottom. FIG. 3 shows other option of the tube implementation—end view, chambers are integrated by a single tube body. Different structures of the tube chambers organizing are possible. The tube materials: plastic, aluminum, cardboard. The combination of different materials is possible. The tube chambers, except for the main product, can contain salt, juice, spices, seasonings.

The offer is illustrated by the following examples.

### FIRST EXAMPLE

Processed or other liquideous cheese is used.

Proportions per 100 g of the product: 50-90 g of bread, 10-50 g of the processed cheese. At option: ketchup: 0-20 g. Mayonnaise: 0-20 g. Mustard: 0-20 g.

### SECOND EXAMPLE

Meat, sausage, chicken, liver or fish paste, different types of meat or fish are used. Salt, spices, vegetable herbs and seasonings are placed in other chamber(s).

Proportions per 100 g of the product: 50-90 g of bread, meat, fish or other type of paste: 10-50 g.

### THIRD EXAMPLE

Meat, sausage, chicken, liver or fish paste, or any other derivative of meat or fish paste are used (it is possible to use various types of meat or fish).

Processed or other liquideous cheese is added. One or several tuba chambers are applied.

Proportions per 100 g of the product: 50-80 g of bread, meat or fish, or other type of paste: 10-30 g, cheese: 10-30 g. To taste—ketchup: 0-20 g, mayonnaise: 0-20 g, mustard: 0-20 g.

Advantage of the proposed solution over analogs is use of the product in all cycles—from production to sale of finished goods and its consumption.

What is claimed is:

1. A method of production of a food product, comprising:
packaging a product in tubes, wherein the tube being injected by a bread.

2. The method according to claim 1, wherein the tube has at least a single chamber.

3. The method according to claim 1, further comprising preparing the bread in a form of paste or small fragments prior to injecting.

4. The method according to claim 3, further comprising mixing the bread with a processed or soft cheese having a proportion per 100 g of the food product: 50-90 g of the bread and 10-50 g of the processed cheese.

5. The method according to claim 3, further comprising mixing the bread with a paste, having a proportion per 100 g of the food product: 50-90 g of the bread; 10-50 g of a meat or a fish paste.

6. The method according to claim 3, further comprising mixing the bread with a paste and a processed or soft cheese, having a proportion per 100 g of the food product: 50-90 g of the bread, 5-25 g of a meat or a fish paste, 5-25 g of a processed or soft cheese.

7. The method according to claim 1, wherein the tube has at least two chambers, a first chamber containing the bread.

8. The method according to claim 7, further comprising filling a second chamber with a soft or processed cheese.

9. The method according to claim 8, further comprising filling a third chamber with a meat or a fish paste.

10. The method according to claim 7, further comprising filling a second chamber with a meat or a fish paste.

11. The method according to claim 7, further comprising filling the tube chambers with ketchup, mayonnaise and mustard.

12. The method according to claim 11 having 0-20 g of ketchup, 0-20 g of mayonnaise, 0-20 g of mustard, per 100 g of the product.
